(19) United States
(12) Patent Application Publication
(10) Pub. No.: US 2026/0045704 A1
(43) Pub. Date: Feb. 12, 2026

(54) ANTENNA DEVICE

(71) Applicant: CANON KABUSHIKI KAISHA, Tokyo (JP)

(72) Inventor: YU TANAKA, Tokyo (JP)

(21) Appl. No.: 19/291,432

(22) Filed: Aug. 5, 2025

(30) Foreign Application Priority Data
Aug. 8, 2024 (JP) 2024-133273

(51) Int. Cl. H01Q 21/20; H01Q 1/22; H01Q 1/42; H01Q 3/12

(52) U.S. Cl. CPC H01Q 21/205; H01Q 1/22; H01Q 1/42; H01Q 3/12

(57) ABSTRACT

An antenna device comprises a first antenna, a plurality of second antennas arranged apart from a predetermined point of the first antenna, and performs to execute positioning of a target object in a first range by using the first antenna and a first antenna group including a plurality of the second antennas, and execute positioning of a target object in a second range at least a part of which is different from the first range by using a second antenna group including a plurality of the second antennas at least one of which is different from antennas included in the first antenna group, and the first antenna.

### BACKGROUND

### Field of the Technology The present disclosure relates to an antenna device that performs positioning of a target object.

### Description of the Related Art

In recent years, a communication system with improved tracking and security utilizing position information by wireless communication using a very wide frequency band called ultra-wide band (UWB) has been studied. Since ultra-wide band signals spanning over several hundred MHz or more on frequency axis can be observed as pulse signals on time axis, position information can be specified using time information for transmitting and receiving the pulse signals. The position information is represented as coordinates on a two dimensional plane or a three dimensional plane by preparing a plurality of antennas and calculating a path difference between pulse signals received by the plurality of antennas.

Patent Document 1 discloses a control method of a window glass or a sunroof of an automobile using an UWB system. In Japanese Patent Application Publication No. 2023-164404, the UWB system is used as a pinching prevention function for an electric power window to further reduce the occurrence of pinching cases and a vehicle communication function via a user's mobile terminal or vehicle key.

Here, since a variation in a propagation environment between antennas is detected, a channel impulse response is not suitable for a portable apparatus placed in an environment unpredictable by the user, and triangulation can cause false determination in principle when any of the selected antennas goes out of line of sight. For this reason, it is necessary to arrange a plurality of antenna sets including a combination of a plurality of antennas so as not to be out of line of sight in order to perform positioning in a wide range, and it is a problem that the number of antennas increases.

### SUMMARY

Therefore, an object of the present disclosure is to provide a technique for performing highly accurate positioning in a wide range while reducing the number of antennas.

In order to achieve the above object, an antenna device according to one aspect of the present disclosure is an antenna device comprising: a first antenna; a plurality of second antennas arranged apart from a predetermined point of the first antenna; at least one processor; and a memory; wherein the at least one processor is configured, by executes executing computer executable instructions stored in the memory, to: execute positioning of a target object in a first range by using the first antenna and a first antenna group including a plurality of the second antennas, and execute positioning of a target object in a second range at least a part of which is different from the first range by using a second antenna group including a plurality of the second antennas at least one of which is different from antennas included in the first antenna group, and the first antenna.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is an overall configuration diagram of an antenna device according to one or more aspects of the present disclosure.

FIG. 1B is an overall configuration diagram of the antenna device according to one or more aspects of the present disclosure.

FIG. 1C is an overall configuration diagram of the antenna device according to one or more aspects of the present disclosure.

FIG. 2A is an internal configuration diagram of the antenna device according to one or more aspects of the present disclosure.

FIG. 2B is an internal configuration diagram of the antenna device according to one or more aspects of the present disclosure.

FIG. 3 is a diagram illustrating a communication range of the antenna device according to one or more aspects of the present disclosure. ss

FIG. 4 is a diagram illustrating a positioning range of a 2D-AoA of the antenna device according to one or more aspects of the present disclosure.

FIG. 5 is a diagram illustrating a positioning range of a 3D-AoA of the antenna device according to one or more aspects of the present disclosure.

FIG. 6 is a diagram illustrating an example of processing executed by the antenna device according to one or more aspects of the present disclosure.

FIG. 7A is a diagram illustrating a first state of the antenna device according to one or more aspects of the present disclosure.

FIG. 7B is a diagram illustrating the first state of the antenna device according to the present embodiment.

FIG. 7C is a diagram illustrating the first state of the antenna device according to one or more aspects of the present disclosure.

FIG. 8A is a diagram illustrating a second state of the antenna device according to one or more aspects of the present disclosure.

FIG. 8B is a diagram illustrating the second state of the antenna device according to one or more aspects of the present disclosure.

FIG. 8C is a diagram illustrating the second state of the antenna device according to the present embodiment.

FIG. 9A is a diagram illustrating a third state of the antenna device according to one or more aspects of the present disclosure.

FIG. 9B is a diagram illustrating the third state of the antenna device according to one or more aspects of the present disclosure.

FIG. 9C is a diagram illustrating the third state of the antenna device according to one or more aspects of the present disclosure.

FIG. 10A is an overall configuration diagram of an antenna device according to one or more aspects of the present disclosure.

FIG. 10B is an overall configuration diagram of the antenna device according to one or more aspects of the present disclosure.

FIG. 10C is an overall configuration diagram of the antenna device according to one or more aspects of the present disclosure.

FIG. 11 is a diagram illustrating an example of processing executed by the antenna device according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

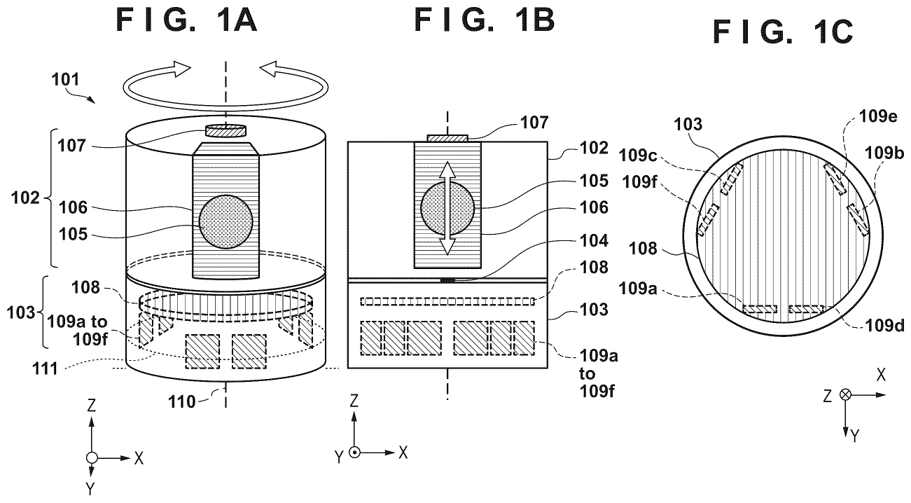

An overall configuration of an antenna device 101 according to the present embodiment will be described with reference to FIGS. 1A to 1C. FIG. 1A is an overhead view from the front direction of the antenna device 101, FIG. 1B is a perspective view on an XZ plane from the front direction of the antenna device 101, and only main functions are extracted. FIG. 1C is a cross-sectional view of the antenna device 101 taken along a dotted line 111 in FIG. 1A.

The antenna device 101 according to the present embodiment performs positioning of a target object, and performs three dimensional positioning such as 3dimension-angle of arrival (3D-AoA) using a plurality of antennas in order to grasp a relative positional relationship with the target object. In the following description, the antenna device 101 is an image capturing device including an image capturing unit, and captures a target object, a person having the target object, a vehicle, or the like, but the antenna device 101 needs not include the image capturing unit. A signal processing circuit of an image or video signal captured by the image capturing unit of the antenna device 101 or an audio signal acquired from a microphone or the like, a power supply function such as a battery or the like, and a drive system accompanied by operation of a motor, a gear, or the like are not described, but are included in the antenna device 101.

The antenna device 101 includes a drive unit 102 and a body unit 103, and the drive unit 102 and the body unit 103 share a rotation axis 110, which is a straight line passing vertically through the center, and are electrically connected by a connection portion 104.

The drive unit 102 includes an image capturing lens 105, a lens drive unit 106, and a first antenna 107 that can perform communication conforming to the Bluetooth Low Energy (BLE) standard. The body unit 103 includes a control board 108, the second antennas 109a to 109c for transmitting/receiving signals for positioning by the UWB, and the second antennas 109d to 109f for receiving. In the following description, the second antennas 109a to 109c and 109d to 109f may be referred to as the second antenna 109 without distinction.

The first antenna 107 is an antenna that can transmit/receive electromagnetic waves in a direction in which the second antenna 109 can transmit/receive electromagnetic waves on a horizontal plane (XY plane). In one example, the first antenna 107 is non-directional on a horizontal plane. In this case, the first antenna 107 is arranged such that a predetermined point such as a center point of the first antenna 107 is positioned on the rotation axis. In one example, the directivity of the first antenna 107 has a shape close to an entire sphere, and as one example, the first antenna 107 is an inverted-F antenna. However, regardless of the type of antenna, a patch antenna, a monopole antenna, a dipole antenna, a loop antenna, or the like may be used. In the following description, the present embodiment is described on an assumption that the first antenna 107 is provided at the drive unit 102. However, the first antenna 107 may be provided in the drive unit. The first antenna can perform UWB communication and communication conforming to the BLE standard. In one example, the first antenna may also be used for communication conforming to another standard such as the Wi-Fi standard.

The second antenna 109 is an antenna that can transmit electromagnetic waves in a direction apart from the rotation axis 110 or can receive electromagnetic waves arriving in the rotation axis direction. The present embodiment is described on an assumption that the second antenna 109 is a patch antenna, but is not limited to this, and may be another type of antenna such as a waveguide antenna or an antenna with a reflector. In the present embodiment, the second antenna 109 is directional on the XY plane. In one example, the second antenna 109 is arranged such that a main beam having the highest gain is positioned in a direction perpendicular to the rotation axis 110. The description will be given on an assumption that the second antenna 109 can execute UWB communication, but the second antenna 109 may also be used for communication conforming to the BLE or other communication.

The present embodiment has been described on the assumption that the UWB is used as broadband communication for transmitting/receiving pulse signals, but other broadband communication may be used. Similarly, the description has been given the assumption that the BLE is used as narrowband communication, but other narrowband communication may be used.

A predetermined point of each of the second antennas 109, for example, a center point is arranged so as to be substantially equidistant from a predetermined point of the first antenna 107, for example, a point at which rotation axis 110 passes through the first antenna 107. In one example, the predetermined points of the plurality of second antennas 109 are arranged on the side surface of the cylinder having the center axis that is the rotation axis 110. In one example, the second antenna 109 is arranged such that a predetermined point of the second antenna 109 is positioned on a circle on an identical plane.

Note that in the present embodiment, three dimensional positioning is performed using a first antenna pair of the second antennas 109a and 109d, a second antenna pair of the second antennas 109b and 109e, and a third antenna pair of the second antennas 109c and 109f and the first antenna 107. For this reason, predetermined points of the first antenna pair, the second antenna pair, and the third antenna pair, for example, the center points may be arranged so as to be substantially equidistant from the predetermined point of the first antenna 107, for example, the point at which rotation axis 110 passes through the first antenna 107. This means that the antenna pairs are used in combination with the first antenna 107 in three dimensional positioning described later. For this reason, the second antennas 109 included in the antenna pair needs to have at least a part of the directivity overlapping.

Note that when used in combination with the first antenna 107 in three dimensional positioning, three or more of the second antennas 109 may be used as an antenna group in which three or more of the second antennas 109 are one group of antennas. One of the second antennas 109 may belong to a plurality of antenna pairs or antenna groups. For example, the second antenna 109a may be able to execute three dimensional positioning by operating as the first antenna pair with the second antenna 109d, and may be able to execute three dimensional positioning by operating as the second antenna pair with the second antenna 109f.

As illustrated in FIG. 1C, the second antennas 109a to 109c and the second antennas 109d to 109f are arranged on the back surface side of the control board 108 every 120 degrees about the rotation axis 110. Since the first antenna 107 is arranged near the rotation axis 110, the second antennas 109 are arranged so as to surround the rotation axis 110. In other words, the second antennas 109 are arranged so as to be equidistant from the rotation axis 110. In one example, the second antennas 109 are arranged so as to surround the first antenna 107 when viewed in the direction of the rotation axis 110. By arranging the second antennas 109 in this manner, it is possible to overlap the range in which the first antenna 107 has high gain and the range in which the second antenna 109 has high gain. By arranging the second antennas 109 such that the distances from the first antenna 107 are uniform, it is possible to prevent the gain of the first antenna 107 from varying in a communication range of each of the plurality of antenna pairs. This enables the second antennas 109 combined with the first antenna 107 to prevent the positioning accuracy of three dimensional positioning from deteriorating.

The direction (main beam direction) in which the gain of the first antenna pair including the second antennas 109a and 109d is the highest is arranged so as to be directed to the front direction (downward direction of FIG. 1A) of the antenna device 101. Similarly, the main beam direction of the second antenna pair including the second antennas 109b and 109e is arranged so as to be directed to the right rear direction of the antenna device 101. The main beam direction of the third antenna pair including the second antennas 109c and 109f is arranged so as to be directed to the left rear direction of the antenna device 101.

For example, a patch antenna whose main beam direction is directed in a direction apart from the rotation axis 110 is used as the second antenna 109. In such a configuration, positioning (2-dimensional-angle of arrival (2D-AoA)) on a two dimensional plane is possible in a range of ±60 degrees, that is, 120 degrees from the main beam direction on the XY plane. Hence, combined use of the first antenna pair, the second antenna pair, and the third antenna pair can execute two dimensional positioning and three dimensional positioning at 360 degrees around the antenna device 101 on the XY plane. Note that since the positioning accuracy depends on the angle swept left and right toward the main beam direction, the positioning angle may be adjusted depending on the necessity of the positioning accuracy. For example, the antenna pairs can be densely arranged in a direction in which positioning accuracy is necessary, and the antenna pairs can be coarsely arranged in a direction in which positioning accuracy is unnecessary. If the installation environment of the antenna device 101 is fixed and positioning in a specific direction is unnecessary, an angle at which the antenna pairs are not arranged may be provided.

In one example, on the XY plane, the antenna pairs of the second antennas 109 are arranged such that predetermined points, for example, center points of the antenna pairs are equally spaced on a circle centered at the first antenna 107. Note that the circle centered at the first antenna 107 is present on the XY plane in the present embodiment, but is not limited to this. For example, when the first antenna 107 is arranged so as to be non-directional on the XZ plane, the second antenna 109 may be arranged on a circle on the XZ plane.

In FIG. 1C, the second antenna 109 is illustrated as having three antenna pairs, but the number of antenna pairs is not limited to this. The present embodiment has been described on the assumption that the first antenna pair, the second antenna pair, and the third antenna pair use the second antennas 109 different from one another. However, the second antennas 109 of which at least one of them is different may be used, and a plurality of antenna pairs may share one second antenna 109.

The drive unit 102 rotates on the body unit 103 about the rotation axis 110 as indicated by the arrow in FIG. 1A, and the lens drive unit 106 moves longitudinally on the body unit 103 in the arrow direction in FIG. 1B, that is, along the rotation axis 110. Hence, by matching the front direction of the image capturing lens 105 of the image capturing unit with the direction of the image capturing target that is a target object at the time of capturing, it is possible to track the image capturing target at a maximum of 360 degrees in the horizontal direction and 180 degrees in the vertical direction. Note that the lens drive unit 106 may alternatively or additionally include a mechanism that adjusts the angle of elevation and the angle of depression of the image capturing lens 105.

The connection portion 104 including a rotation mechanism includes a rotary connector that passes a signal line inside thereof for not only physically connecting but also for electrically connecting the drive unit 102 and the body unit 103. Note that a through hole may be provided in place of the rotary connector, and a signal line may be passed therethrough. However, when rotation is limited by the extra length of the signal line, 360 degrees in the horizontal direction may be achieved by switching the rotation direction to the left and right.

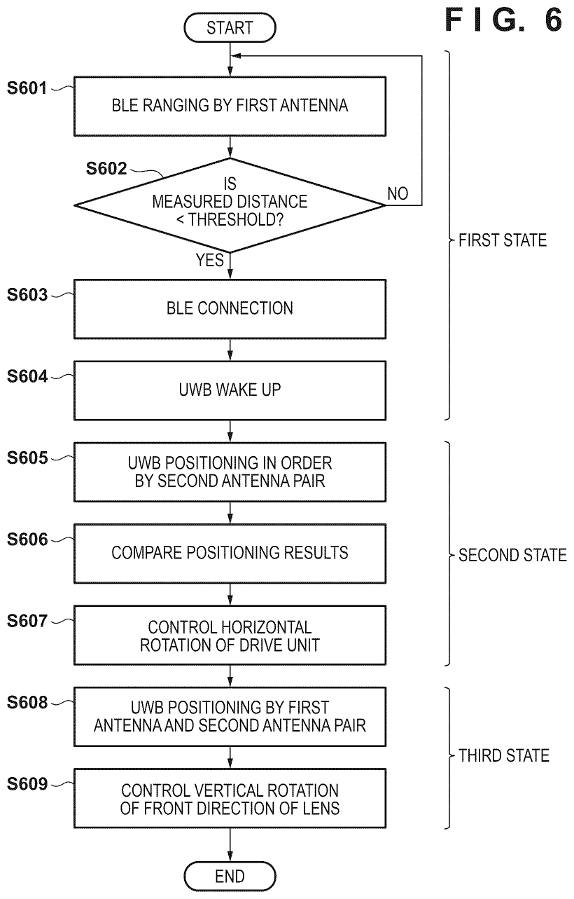

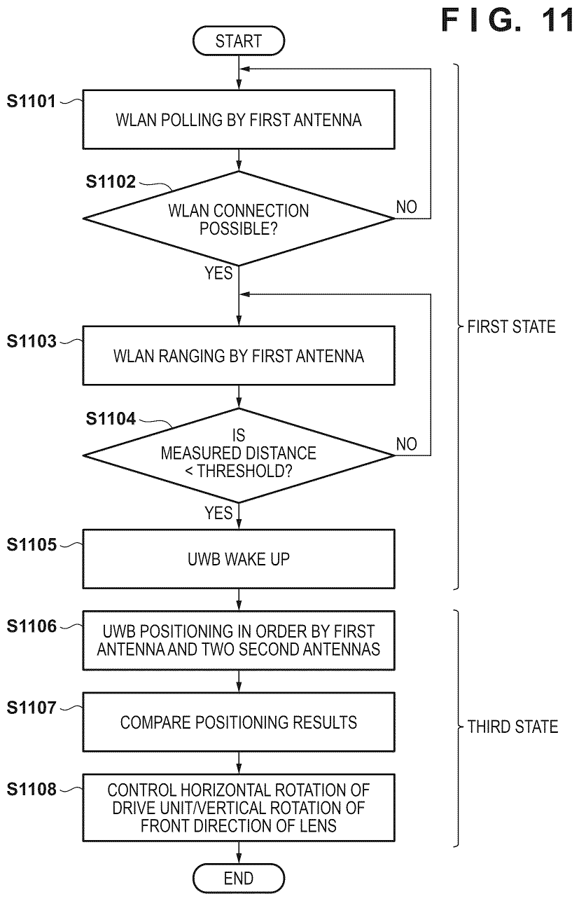

The control board 108 includes a processor and a memory, and operates as a control unit that executes control operation of the entire antenna device 101 including positioning processing described later with reference to FIGS. 6 and 11. The control board 108 also functions as a drive control unit that controls the rotation along the rotation axis of the drive unit 102, and a lens drive unit that controls the position and angle in the up-down (Z axis) direction of the image capturing lens of the image capturing unit.

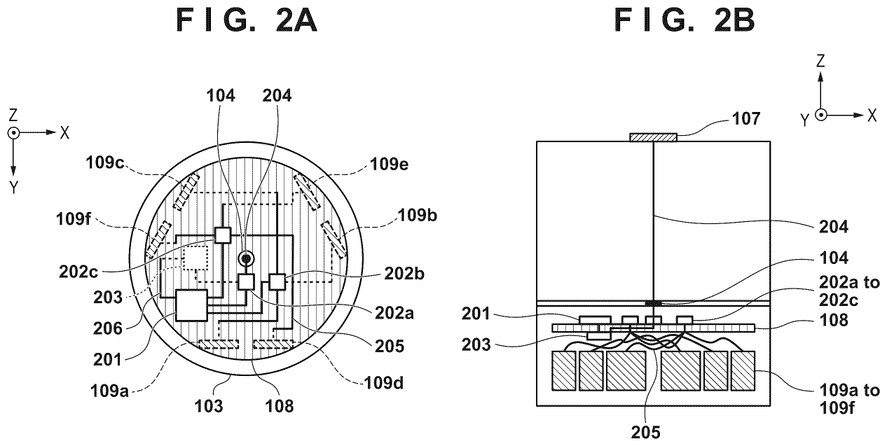

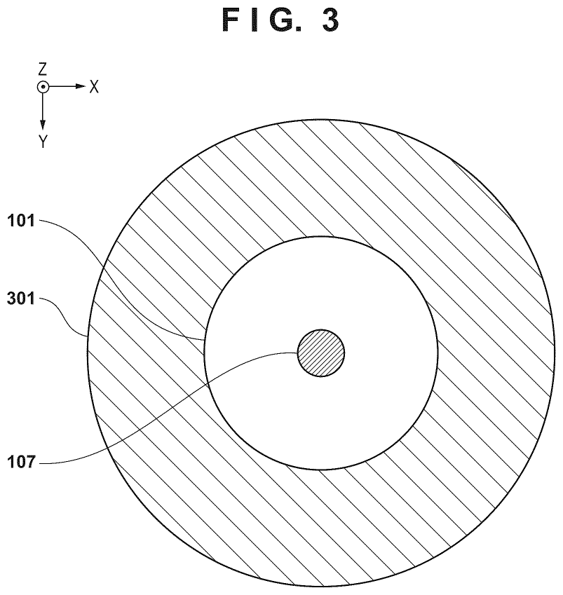

FIGS. 2A and 2B are internal configuration diagrams of the antenna device 101 according to the present example. FIG. 2A is a perspective view of the body unit 103 as viewed from a direction (Z axis direction) along the rotation axis, and FIG. 2B is a perspective view as viewed from a front direction (Y direction) of the antenna device 101.

The control board 108 includes a UWB integrated circuit (IC) 201, control switches 202a to 202c, a BLE IC 203, a radio frequency (RF) line 204, a UWB RF line 205, and a control line 206, other than the antenna 109. In the drawings, a solid line indicates arrangement on the front side (front surface) of the control board 108, and a broken line indicates arrangement on the back side (back surface) or an inside (inner layer) of the control board 108, but the arrangement is not limited to this and can be arbitrarily changed.

Here, the control switch 202a is a single-pole double-throw (SPDT) that connects any of the UWB IC 201 and the BLE IC 203 with the RF line 204. At this time, the UWB IC 201 and the BLE IC 203 are connected by the control line 206, and the BLE IC 203 controls the control switch 202a by a control line (not illustrated) by synchronizing transmission/reception timings in the BLE and the UWB. The BLE IC 203 can transition (hereinafter, described as wake up) the operation mode of the UWB IC 201 from a low power consumption state to an activation state via the control line 206.

The control switch 202b is a single-pole triple-throw (SP3T) that connects any of the second antennas 109a, 109b, and 109c with the UWB IC 201 via the UWB RF line 205.

Similarly, the control switch 202c is an SP3T that connects any of the second antennas 109d, 109e, and 109f with the UWB IC 201 via the UWB RF line 205. At this time, the UWB IC 201 controls the control switch 202b and the control switch 202c by a control line (not illustrated).

The RF line 204 is a wiring having impedance of 50 ohms such as a thin coaxial line passing through the connection portion 104, and connects the first antenna 107 and the control board 108 of the antenna device 101. The UWB RF line 205 is a wiring on or in a board having impedance of 50 ohms such as a microstrip line or a coplanar line in the control board 108. On the other hand, the UWB RF line 205 is also a wiring separated from a board having impedance of 50 ohms such as a thin coaxial line, and connects the second antennas 109a to 109f and any of the control switches 202a to 202c.

Note that the second antenna 109 is not limited to a printed circuit board (PCB) of rigid FR-4, and may be formed of a flexible printed circuit (FPC) or a molded interconnect device (MID). The connection form between the second antenna 109 and the control board 108 is not limited to the thin coaxial line, and may be a strip line or the like. At least any of the second antennas 109 may be not a patch antenna but a monopole antenna or an inverted-F antenna.

FIG. 3 is a diagram illustrating a ranging range in the XY plane of the first antenna 107 of the antenna device 101 according to the present example.

The first antenna 107 is an antenna that can receive electromagnetic waves transmitted in the antenna device 101 direction from a communication range 301 in which communication can be performed using the BLE or the UWB, and can transmit electromagnetic waves in a direction indicated by the communication range 301 from the antenna device 101. In this communication range 301, the antenna device 101 can perform ranging. That is, the communication range 301 is a ranging range of the antenna device 101. Since the first antenna 107 is non-directional on the XY plane, a region surrounding the entire periphery of the antenna device 101 is illustrated as the communication range 301 in FIG. 3. A predetermined point such as the center point of the first antenna 107 is arranged at a position close to the exterior of the antenna device 101 and close to the rotation axis. Here, in a case where the antenna device 101 is made of metal or conductive resin, it is possible to avoid an influence on the characteristics of the antenna by arranging the first antenna 107 in an opening portion of the metal or the conductive resin. Whether to execute communication by the BLE or to execute communication by the UWB in the communication range 301 is exclusively selected by the control switch 202a. This enables the distance to the target object to be calculated based on the received signal intensity of a predetermined signal such as a beacon signal of the BLE or the UWB transmitted from the target object positioned within the communication range 301 of the first antenna 107.

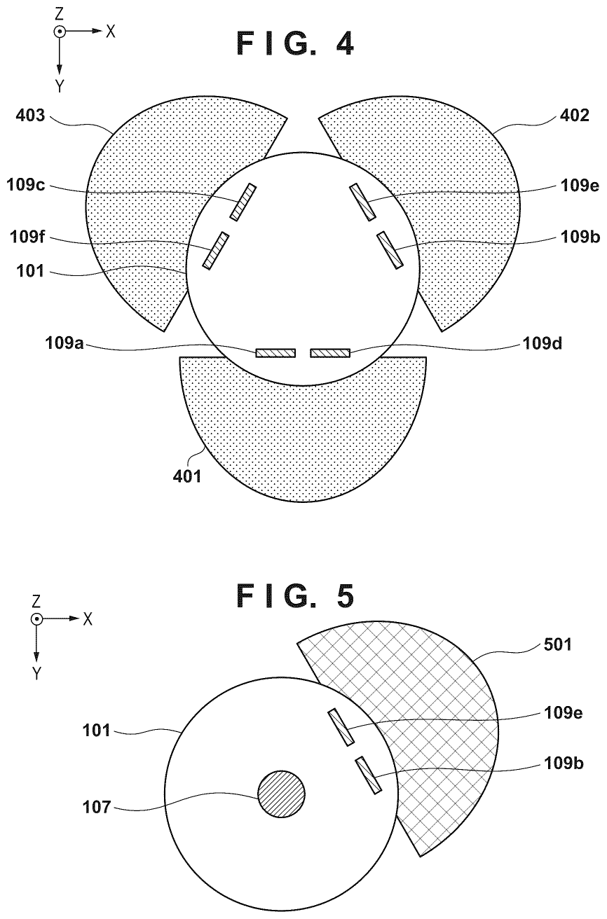

FIG. 4 is a diagram illustrating a positioning range on the XY plane of the 2D-AoA using the antenna pair of the second antennas 109 of the antenna device 101 according to the present embodiment.

Specifically, the first antenna pair of the second antennas 109a and 109d can communicate by the UWB in a communication range 401, and the second antenna group of the second antennas 109b and 109e can communicate by the UWB in a communication range 402. Similarly, the third antenna group of the second antennas 109c and 109f can communicate by the UWB in a communication range 403. Which of the communication range 401, the communication range 402, and the communication range 403 to be used for performing communication is exclusively selected by the control switch 202b and the control switch 202c. In any case, the distance and angle of the target object can be calculated with two dimensional coordinates using a two dimensional positioning method such as the 2D-AoA. Note that the communication range 401, the communication range 402, and the communication range 403 may at least partially overlap. The present embodiment has been described on the assumption that the second antenna 109 performs two dimensional positioning on the XY plane, but is not limited to this, and may perform two dimensional positioning on an arbitrary plane.

The antenna device 101 according to the present embodiment includes the plurality of antenna pairs. Therefore, in one example, the antenna device 101 may simultaneously perform two dimensional positioning in a plurality of the communication ranges 401 to 403. This enables the two dimensional positioning to be completed in a short time. In one example, the antenna device 101 may perform ranging using the first antenna 107, and execute two dimensional positioning using an antenna pair within the communication ranges 401 to 403 when detecting that the target object exists within the communication range of the first antenna 107 based on the ranging result.

FIG. 5 is a diagram illustrating a positioning range of three dimensional positioning of the antenna device 101 according to the present embodiment.

Specifically, the first antenna 107 and the second antenna pair of the second antennas 109b and 109e can communicate by the UWB in a communication range 501, and at this time, either the first antenna 107 or the second antenna 109b performs both transmission and reception of pulse signals. The addition of the first antenna 107 to the second antenna pair enables positioning in the vertical direction (Z axis direction), and can calculate the distance and angle of the target object with three dimensional coordinates using the 3D-AoA. Note that when the first antenna pair is selected, the three dimensional positioning of the target object is executed in a range corresponding to the communication range 401 together with the first antenna 107. Similarly, when the third antenna pair is selected, the three dimensional positioning of the target object is executed in a range corresponding to the communication range 403 together with the first antenna 107. That is, the communication ranges 401 to 403 are positioning ranges of the antenna device 101.

In a use case where the antenna device 101 captures a target object 701, the control board 108 performs control so that the antenna device 101 assumes the following first to third states in accordance with a track 702 on which the target object 701 moves.

First, the antenna device 101 performs ranging using the BLE in the first state (S601 to S604 in FIG. 6). Next, the antenna device 101 performs two dimensional positioning by the 2D-AoA by the UWB in the second state (S605 to S607 in FIG. 6). Finally, the antenna device 101 performs positioning by three dimensional positioning by the UWB in the third state (S608 to S609 in FIG. 6). Note that the first antenna 107 is used in the first state to perform ranging. In the second state, one antenna pair of the second antennas 109 is used to perform two dimensional positioning. In the third state, three dimensional positioning is executed using the first antenna 107 and one antenna pair of the second antennas 109. Note that the two dimensional positioning or the three dimensional positioning may be executed a plurality of times while switching the antenna pair of the second antennas 109.

FIG. 6 is a control sequence illustrating one example of processing executed by the control board 108 of the antenna device 101 according to the present embodiment. The processing of FIG. 6 is achieved by the processor of the control board 108 executing a program stored in the memory of the control board 108. Naturally, the control board 108 can execute other processing such as signal processing of an image or a video signal captured by the antenna device 101, signal processing of an audio signal input from a microphone or the like, power supply management of a battery or the like, and a data management and storage method of a RAM, a ROM, or the like.

The target object 701 includes a wireless communication function by the BLE and the UWB, and in the BLE, the target object 701 serves as a peripheral to intermittently transmit (poll) a predetermined signal such as an advertising packet. In the UWB, the target object 701 operates as a tag. Here, since the power consumption and the discovery probability are contradictory, the target object 701 may dynamically change the transmission interval of the advertising packet. Note that the target object 701 is assumed to be a human body that possesses a portable accessory device (tag) including a communication function by the BLE and a communication function by the UWB, but in place of the human body, it may be a drone, an automatic guided vehicle, an automobile, or the like.

The antenna device 101 serves as a central of the BLE and performs ranging based on the polling from the target object 701 (S601). Specifically, from the payload included in the advertising packet received by the first antenna 107, the BLE IC 203 calculates the distance from the antenna device 101 to the target object 701.

Based on the distance to the target object 701, the antenna device 101 determines (yes in S602) that the target object 701 is in proximity to the antenna device 101 if the distance is within a preset threshold, and connects to the target object 701 via BLE communication (S603). The antenna device 101 wakes up the UWB IC 201 (S604). Here, by handing over, to the UWB IC 201, the address included in the advertising packet of the target object 701 connected by the BLE, the BLE IC 203 can seamlessly perform the connection by the UWB (in and after S605). Note that S602 may be performed a plurality of times, or the threshold value may be individually set depending on the address of the target object 701. S603 is not essential, and S604 can be executed based on the ranging result of S602.

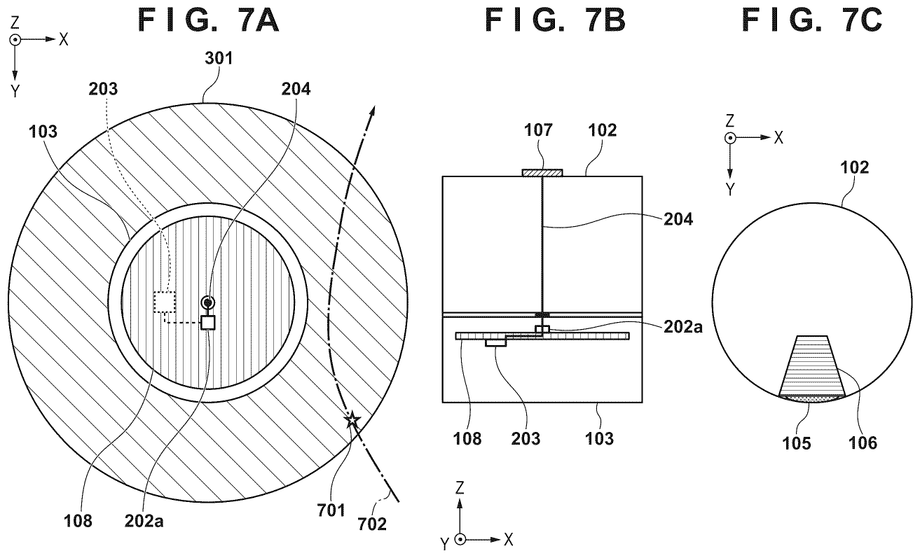

When S601 to S604 are defined as the first state, FIGS. 7A to 7C illustrate the configuration of the antenna device 101 in the first state. FIG. 7A illustrates a ranging range on the XY plane of the antenna device 101, FIG. 7B is a perspective view from the front direction (Y direction) of the antenna device 101, and FIG. 7C is a perspective view of the antenna device 101 as viewed from above, and only main functions are extracted. Note that components not used for ranging, such as the antenna 109 of the antenna device 101, are omitted.

In FIGS. 7A and 7B, the BLE IC 203 is connected to the first antenna 107 via the RF line 204 by the control switch 202a. Here, as illustrated in FIG. 7A, it is assumed that the target object 701 exists in the communication range 301 in which the BLE can communicate. Therefore, as a result of the determination in S602, the antenna device 101 determines that the target object 701 is positioned within the communication range 301 (yes in S602). Note that in FIG. 7C, the lens drive unit 106 and the image capturing lens 105 may be at any positions, and may be directed in the front direction (downward in the figure), which is the initial position, for example.

Next, the antenna device 101 operates as an anchor of the UWB, and performs two-way ranging (TWR) with the target object 701 operating as a tag of the UWB, thereby performing positioning of the target object 701 (S605). Specifically, by performing two dimensional positioning while sequentially or randomly switching the first to third antenna pairs, the antenna device 101 calculates the distance and angle to the target object 701 with each antenna pair. To be precise, the distance between the antenna device 101 and the target object 701 is calculated by the TWR, and the angle from the antenna device 101 to the target object 701 in the two dimensional plane is calculated by the 2D-AoA. Here, in a case where the positioning result to the target object 701 is obtained by the plurality of antenna groups, the positioning result of the antenna group having the closest distance value is adopted (S606), and the antenna device 101 rotates the drive unit 102 in the front direction of the closest antenna pair (S607). Note that the method of calculating the distance in the two dimensional positioning is not limited to the TWR, and other methods may be used. Two dimensional positioning systems such as symmetrical double-sided TWR (SDS-TWR), time difference of arrival (TDoA), and phase difference of arrival (PDoA) may be arbitrarily combined. In a case where two dimensional positioning is performed by a positioning method in which the antenna device 101 receives a signal transmitted from the target object 701, such as PDoA, reception may be performed simultaneously by a plurality of antenna pairs, and two dimensional positioning of the target object may be performed in parallel by the plurality of antenna pairs. This enables the two dimensional positioning by the plurality of antenna pairs to be completed in a short time.

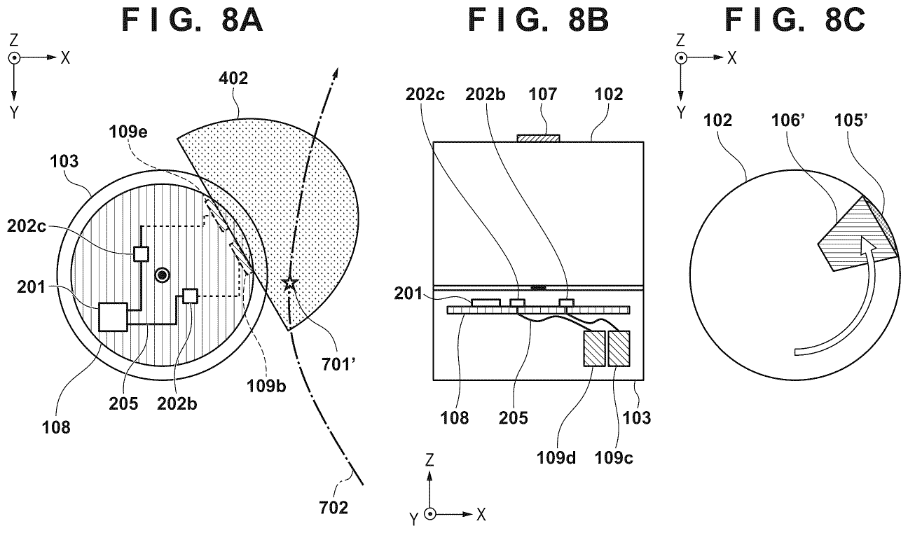

When S605 to S607 are defined as the second state, FIGS. 8A to 8C illustrate the second state of the antenna device 101 according to the present embodiment. FIG. 8A illustrates a positioning range on the XY plane of the antenna device 101, FIG. 8B illustrates a perspective view from the front direction (Y direction) of the antenna device 101, and FIG. 8C is a view of the image capturing lens 105 of the antenna device 101 as viewed from above, and only main functions are extracted.

As illustrated in FIGS. 8A and 8B, the UWB IC 201 is connected to the second antenna 109b via the UWB RF line 205 by the control switch 202b. Similarly, the UWB IC 201 is connected to the second antenna 109e via the UWB RF line 205 by the control switch 202c. Note that the position of the target object 701 is assumed to be within the communication range 402 in which the UWB can communicate. Therefore, in S606, the antenna device 101 can determine that the target object 701 is positioned within the communication range 402 of the second antenna pair based on the positioning result of the second antenna pair. Therefore, as illustrated in FIG. 8C, the lens drive unit 106 and the image capturing lens 105 are directed in a right rear direction (upper right direction in the figure) rotated by 120 degrees from the initial position. Note that the rotation direction of the drive unit 102 may be not right rotation but left rotation. The angle of rotation is not necessarily 120 degrees, and may follow movement of the target object 701 in real time, for example.

Finally, the antenna device 101 performs positioning again based on the TWR with the target object 701, which is a tag of the UWB, while remaining as an anchor of the UWB (S608). Specifically, by performing the 3D-AoA with the first antenna 107 and the second antenna pair of the second antennas 109, the antenna device 101 calculates the distance and angle to the target object 701. Specifically, the distance is calculated by the TWR, and the angle on the three dimensional plane is calculated by the 3D-AoA. The antenna device 101 rotates the lens drive unit 106 based on the positioning result. The antenna device 101 includes at least any of a drive mechanism that performs movement along the Z axis of the image capturing lens 105 and a mechanism that adjusts the angle of elevation and the angle of depression of the image capturing lens 105. These mechanisms enable the antenna device 101 to direct the front direction of the image capturing lens 105 to the target object 701. Note that the antenna device 101 may adjust the front direction of the image capturing lens 105 so that the target object 701 is included within the image capturing range of the image capturing unit.

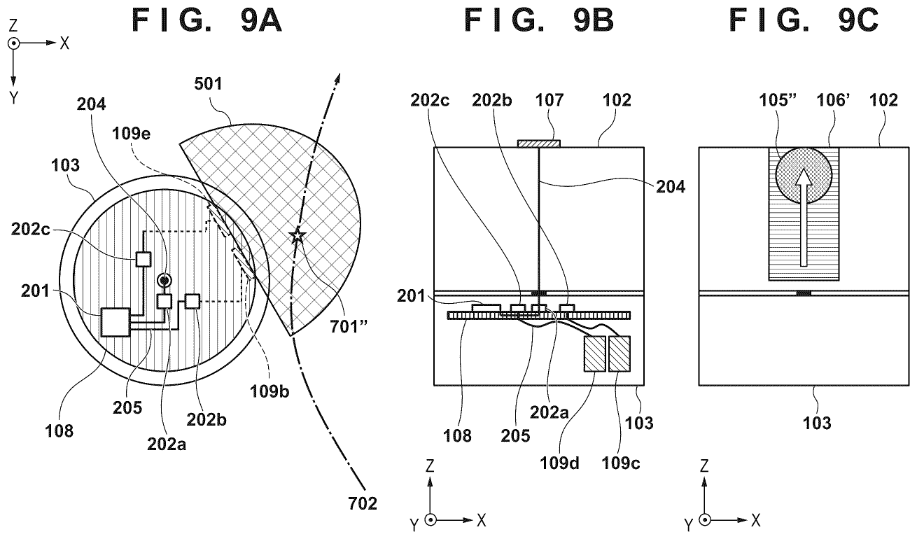

When S608 to S609 are defined as the third state, FIGS. 9A to 9C illustrate the third state of the antenna device 101 according to the present embodiment. FIG. 9A illustrates a positioning range of the antenna device 101, FIG. 9B is a perspective view from the front direction of the antenna device 101, and FIG. 9C is a view of the antenna device 101 as viewed from above, and only main functions are extracted.

In FIGS. 9A and 9B, the UWB IC 201 is connected to the first antenna 107 via the RF line 204 by the control switch 202a. However, the first antenna 107 is used only for reception in the UWB. The UWB IC 201 is connected to the second antenna 109b via the UWB RF line 205 by the control switch 202b. Similarly, the UWB IC 201 is connected to the second antenna 109e via the UWB RF line 205 by the control switch 202c. The position of the target object 701 is included in the communication range 501 in which the UWB can communicate. In FIG. 9C, while the lens drive unit 106 is directed in a right rear direction rotated by 120 degrees from the initial position, and the image capturing lens 105 is directed in an upper direction (upper direction in the figure).

Note that the operations of the lens drive unit 106 and the image capturing lens 105 may cooperate with signal processing of a video signal. In particular, in a case where the antenna device 101 includes an auto focus (AF) function, it is conceivable to give priority to tracking of the target object 701 by signal processing of a video signal, and to supplementarily use tracking using the UWB.

When there are a plurality of target objects 701, the antenna device 101 may determine the target object to be tracked based on address information determined in advance in association with the priority. Alternatively, the antenna device 101 may distinguish and track the plurality of target objects 701 by adopting a median value of positions where the plurality of target objects 701 are arranged, adjusting a focal length of the image capturing lens 105, or the like.

The relationship between the peripheral and the central in the BLE and the relationship between the anchor and the tag in the UWB can be interchanged.

In the third state, the first antenna 107 may be responsible for transmission of an advertising packet of the UWB, and the second antenna 109b may be responsible for reception of an advertising packet of the UWB. In this case, the advertising packet transmitted by the first antenna 107 may be received by a plurality of antenna pairs. This can determine the position of the target object 701 based on the positioning results of the plurality of antenna pairs when the detection accuracy of the target object 701 is likely to decrease, such as near an end portion of the communication range of the antenna pair of the second antennas 109.

As illustrated in FIG. 5, the range corresponding to the communication ranges 401 to 403, that is, the entire periphery of the antenna device 101 can be as the positioning range on the three dimensional plane with a small number of antennas by selection of the first to third antenna pairs with the first antenna 107 being common. Assuming that the number of antenna pairs equal to the number of divisions of the positioning range is N, since each antenna pair includes two antennas, the antenna device 101 includes 2*N+1 antennas. However, it may fall below 2*N+1 by providing an angle of absence. Reducing the number of antennas is a synonym for reducing the mounting region of the antennas, and can contribute to downsizing of the housing size of the antenna device 101.

Each antenna pair is given directivity, and the detection accuracy of the advertising packet is enhanced, whereby the positioning of the target object can be performed with high accuracy.

As described above, the antenna device according to the present embodiment can have an image capturing region of 360 degrees in the horizontal direction and 180 degrees in the vertical direction while reducing the mounting region of the antenna. This can achieve an antenna device that can highly accurately detect a target object in a wide range while reducing the number of antennas.

### Second Embodiment

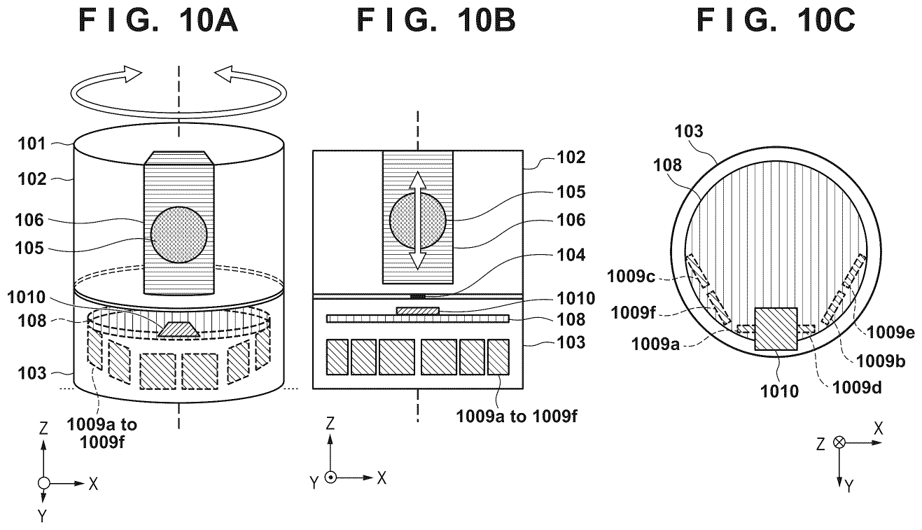

FIGS. 10A to 10C are overall configuration diagrams of the antenna device 101 according to the present example. Note that the same reference signs are given to similar configurations to those of the first embodiment, and the description thereof will be partially omitted. FIG. 10A is an overhead view from the front direction of the antenna device 101, FIG. 10B is a perspective view from the front direction of the antenna device 101, and only main functions are extracted.

The antenna device 101 includes the drive unit 102 and the body unit 103, and the drive unit 102 and the body unit 103 share an axis (dotted line in the figure) passing vertically through the center, and are electrically connected by the connection portion 104. The drive unit 102 includes the image capturing lens 105 and the lens drive unit 106. The body unit 103 includes the control board 108, second antennas 1009a to 1009c that perform transmission/reception for positioning by the UWB, second antennas 1009d to 1009f that perform reception, and a first antenna 1010 that performs transmission/reception for communication by Wi-Fi. In the following description, the second antennas 1009a to 1009f may be called second antennas 1009 without distinction. The second antenna 1009 may have a similar configuration except for the arrangement of the second antennas 109 described with reference to FIG. 1.

The first antenna 1010 is integrated as a wireless module (not illustrated) including a wireless communication function by Wi-Fi (registered trademark), and the wireless module (not illustrated) is mounted on a board end of the control board 108. Note that the first antenna 1010 may only include the antenna function as a form in which the RF function and the antenna function are separately configured and then connected by a thin coaxial line in the wireless module (not illustrated).

Here, the drive unit 102 moves laterally on the body unit 103 in the arrow direction in FIG. 10A, that is, about the rotation axis, and the lens drive unit 106 moves up and down on the body unit 103 in the arrow direction in FIG. 10B, that is, along the rotation axis. FIG. 10C is a perspective view from the rotation axis direction of the body unit 103, and only main functions are extracted.

An antenna pair including the second antennas 1009, which are two patch antennas, is arranged on the back surface side of the control board 108 every 60 degrees about the rotation axis. At this time, the main beam direction of the first antenna pair in which the second antennas 1009a and 1009d are arranged side by side is arranged so as to be directed to the front direction of the antenna device (Y direction in FIG. 1A). Similarly, an opening surface of the second antenna pair in which the second antennas 1009b and 1009e are arranged side by side is arranged so as to be directed to a right front direction, and an opening surface of the third antenna pair in which the second antennas 1009c and 1009f are arranged side by side is arranged so as to be directed to a left front direction. Hence, by combining the first to third antenna pairs, it is possible to perform positioning of a range of 240 degrees to the left and right from the front direction of the antenna device 101 on the XY plane. That is, in a case where positioning needs not be performed in a predetermined range, for example, a range of 120 degrees about a rear surface direction (-Y direction) of the antenna device 101, for example, the second antenna 1009 is arranged so as not to overlap with the predetermined range. Note that the predetermined range in which positioning needs not be performed may partially overlap with the second antenna 1009. For example, in the example of FIG. 10, a range of 180 degrees about the rear surface direction of the antenna device 101 may be a range in which positioning is not performed. By this, the positioning in the side surface direction (±X direction) of the antenna device 101, which is an end portion of the range in which the positioning is performed, can be performed with high accuracy.

The first antenna 1010 is arranged so as to be directed to the front direction (Y direction) of the antenna device 101, and exhibits strong directivity in the front direction of the antenna device 101. In this manner, when the antenna device 101 is arranged on a wall surface or the like, the antenna pair needs not be arranged behind the antenna device 101.

In a use case where the antenna device 101 captures the target object 701, the antenna device 101 performs control so as to assume the first state and the third state in accordance with the track 702 on which the target object 701 moves.

First, in the first state, the antenna device 101 performs ranging using the BLE using the first antenna 1010 (S1101 to S1105 in FIG. 11). Next, the antenna device 101 performs positioning by the 3D-AoA by the UWB using the first antenna 1010 and an antenna pair including two of the second antennas 1009 in the third state (S1106 to S1108 in FIG. 11).

FIG. 11 is a control sequence of the antenna device 101 according to the second embodiment. The target object 701 includes a wireless communication function by Wi-Fi and the UWB, and in Wi-Fi, the target object 701 serves as a client to receive a beacon signal intermittently transmitted from the antenna device 101 (S1101). In UWB communication, the target object 701 operates as a tag.

The antenna device 101 operates as a Wi-Fi access point, and after confirming that connection to the target object 701 having received a connection request has been made via Wi-Fi (yes in S1102), performs ranging based on a predetermined signal intensity received from the target object 701 (S1103). Specifically, from the payload included in the packet received by the first antenna 1010, a Wi-Fi IC (not illustrated) calculates the distance from the antenna device 101 to the target object 701. Here, since the power consumption and the discovery probability are contradictory, the interval at which the target object 701 transmits the beacon signal may be dynamically changed.

If the distance to the target object 701 measured in S1103 is within a preset threshold, the antenna device 101 determines (yes in S1104) that the target object 701 is in proximity to the antenna device 101, and wakes up the UWB IC 201 (S1105). Here, the Wi-Fi IC (not illustrated) may hand over, to the UWB IC 201, the address of the target object 701 connected by Wi-Fi. S1101 to S1105 are included in the first state.

Note that the relationship between the client and the access point in Wi-Fi and the relationship between the anchor and the tag in the UWB can be interchanged.

The antenna device 101 serves as an anchor of the UWB, and executes two-way ranging (TWR) with the target object 701, which is a tag of the UWB, to perform positioning (S1106). Specifically, by combining the first antenna 1010 and the first to third antenna pairs and performing the 3D-AoA while sequentially or randomly switching the first to third antenna pairs, the distance and angle to the target object 701 are calculated by the first antenna 1010 and any of the antenna pairs. To be precise, the distance is obtained by the TWR, and the angle from the antenna device 101 to the target object on the three dimensional plane is obtained by the 3D-AoA. The antenna device 101 rotates the drive unit 102 and the lens drive unit 106 (S1108) based on the positioning result of the antenna pair having the closest distance to the target object 701 (S1107). As a result, the image capturing lens 105 comes up against the target object 701.

As described above, the antenna device according to the present embodiment performs ranging of the distance to the target object, and when determining that the target object is positioned around the antenna device, specifies the distance and direction to the target object by three dimensional positioning.

### Other Embodiments

The present embodiment has been described on the assumption that the antenna pair including the two second antennas 109 is provided not at the drive unit 102 but at the body unit 103 and does not rotate on the horizontal plane. However, the antenna pair may be provided in the drive unit 102 and rotate on a horizontal plane. By this, when a direction from the antenna device 101 to the target object 701 is specified as a result of, for example, two dimensional positioning or three dimensional positioning, a main lobe direction of any antenna pair may be directed to the target object 701. By this, by executing the three dimensional positioning again, positioning of the target object 701 can be performed with higher accuracy. In this case, in S607, the main beam direction of the antenna pair having the main beam direction closest to the target object 701 may be directed to the direction of the target object 701. Alternatively, a predetermined antenna pair having a main beam direction close to the image capturing direction of the image capturing lens 105, that is, the first antenna pair in the case of FIG. 1C may be directed to the direction of the target object 701.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-133273, filed Aug. 8, 2024 which is hereby incorporated by reference herein in its entirety.

What is claimed is:

1. An antenna device comprising:
a first antenna;
a plurality of second antennas arranged apart from a predetermined point of the first antenna;
at least one processor; and
a memory;
wherein the at least one processor is configured, by executes executing computer executable instructions stored in the memory, to:
execute positioning of a target object in a first range by using the first antenna and a first antenna group including a plurality of the second antennas, and
execute positioning of a target object in a second range at least a part of which is different from the first range by using a second antenna group including a plurality of the second antennas at least one of which is different from antennas included in the first antenna group, and the first antenna.

2. The antenna device according to claim 1, wherein the plurality of second antennas are arranged on a side surface of a cylinder having a center axis that is a straight line passing through the predetermined point.

3. The antenna device according to claim 2, wherein
the at least one processor is further configured, by executes executing computer executable instructions stored in the memory, to execute positioning of a target object in a third range at least a part of which is different from the first range and the second range by using a third antenna group different from the first antenna group and the second antenna group, and the first antenna,
the plurality of second antennas of the first antenna group, the plurality of second antennas of the second antenna group, and a plurality of the second antennas of the third antenna group are different from one another, and
the first antenna group, the second antenna group, and the third antenna group are equally spaced on the side surface of the cylinder.

4. The antenna device according to claim 1, wherein the at least one processor is configured, by executes executing computer executable instructions stored in the memory, to executes ranging to a target object in a fourth range including the first range and the second range by using the first antenna.

5. The antenna device according to claim 4, wherein
the at least one processor is configured, by executes executing computer executable instructions stored in the memory, to:
executes two dimensional positioning using each of the first antenna group and the second antenna group of the second antennas; and
determines which of the first antenna group and the second antenna group to use to execute positioning in accordance with a result of the two dimensional positioning.

6. The antenna device according to claim 5, wherein the at least one processor is configured, by executes executing computer executable instructions stored in the memory, to determines whether or not to execute the two dimensional positioning based on a ranging result using the first antenna.

7. The antenna device according to claim 5, wherein the at least one processor is configured, by executes executing computer executable instructions stored in the memory, to executes, in parallel, two dimensional positioning using the first antenna group and two dimensional positioning using the second antenna group.

8. The antenna device according to claim 1 further comprising:
a body part;
a drive system configured to rotate along a rotation axis passing through the body part; and
the at least one processor is configured, by executes executing computer executable instructions stored in the memory, to control rotation of the drive system, wherein
the first antenna is arranged such that the predetermined point is positioned on the rotation axis, and
the plurality of second antennas have high gain in a direction apart from the rotation axis.

9. The antenna device according to claim 8, wherein
the drive system is provided with an image capturing lens, and
the at least one processor is configured, by executes executing computer executable instructions stored in the memory, to direct the image capturing lens at a target object based on a result of the positioning.

10. The antenna device according to claim 9, wherein
the drive system further includes a lens drive unit configured to adjust at least any of a vertical position and an angle of elevation and an angle of depression of the image capturing lens, and
the lens drive unit is configured to perform adjustment so as to direct a front direction of the image capturing lens at a target object based on a result of the positioning.

11. The antenna device according to claim 8, wherein
the plurality of second antennas are provided at the drive system,
the at least one processor is configured, by executes executing computer executable instructions stored in the memory, to execute two dimensional positioning using each of the first antenna group and the second antenna group, and
direct a direction in which gain of any of the first antenna group and the second antenna group is high at a target object in accordance with a positioning result of the two dimensional positioning.

12. The antenna device according to claim 1, wherein the first antenna is non-directional on a predetermined plane.

13. The antenna device according to claim 12, wherein the plurality of second antennas are arranged so as to be non-directional on the predetermined plane in a case where directivities of the plurality of second antennas are superimposed.

14. The antenna device according to claim 1, wherein any of the first antenna and the plurality of second antennas are used for broadband communication.

15. The antenna device according to claim 1, wherein the first antenna is also used for narrowband communication.

16. The antenna device according to claim 1, wherein the second antennas are arranged such that a direction in which gain of the second antennas is high does not overlap with a fifth range in which the positioning is not performed.

17. The antenna device according to claim 1, wherein the second antennas are equally spaced.
